(19) United States
(12) Patent Application Publication
(10) Pub. No.: US 2014/0237029 A1
(43) Pub. Date: Aug. 21, 2014

(54) CLOUD-BASED RESOURCE MANAGEMENT

(71) Applicant: Irdeto B.V., Hoofddorp (NL)

(72) Inventors: Andrew Augustine Wajs, Hoofddorp (NL); Calin Ciordas, Hoofddorp (NL); Jeroen Mathias Doumen, Hoofddorp (NL)

(73) Assignee: Irdeto B.V., Hoofddorp (NL)

(21) Appl. No.: 14/262,271

(22) Filed: Apr. 25, 2014

Related U.S. Application Data
(63) Continuation of application No. 14/005,219.

(51) Int. Cl. H04L 29/06

(52) U.S. Cl. CPC H04L 67/42
USPC 709/203

(57) ABSTRACT

The invention involves the migration of at least some of the content discovery and/or resource management tasks from a home network to a remote server by using a proxy device, such as e.g. a DLNA-compatible proxy server or a proxy server compatible with other and/or multiple standards, connected to the devices within the home network and also connected to the resource server via an external, network. The proxy device can obtain content-relation information and, possibly, also: device-related information from the devices within the home network and provide that information to the remote server which can use the information to create an integrated navigation interface for navigating and/or managing content available to all of the devices within the home network.

### FIELD OF THE INVENTION

The present invention relates to content management in a home network.

### BACKGROUND

The number of consumer devices for storing and rendering audiovisual content has dramatically increased in the last years and is expected to continue to do so in the future. It is not unusual to find within a typical house a home network including multiple TV sets, set top boxes, DVD players, and multimedia mobile phones. These devices consume content from a wide range of sources such as broadcast networks, internet streaming servers, personal video recorders, local music library services, local photo archives, etc.

Various companies in the mobile, consumer electronics, PC, and service provider industries are collaborating to establish design guidelines and standards that would enable the interoperability and compatibility of the different devices in a home network. The Digital Living Network Alliance (DLNA) is a non-profit trade organization that is a result of one such collaboration between more than 250 member companies. The DLNA standard provides a protocol for using and sharing content between home networked devices. Other home networking interoperability standards include e.g. Universal Plug and Play (UPnP), Home PNA (HPNA), and custom implementations from various operators. There are many products and home network servers that support DLNA and other similar standards.

While the development of DLNA and other similar standards has improved the interoperability of the devices in a home network, there are still challenges such as e.g. a challenge of scheduling the viewing and recording of programs and of allocating resources for the recordings in a manner that does not create conflicts between the devices. With more devices in a home network capable of playing and storing content, the flow of content between the various content sources and the storage devices in the home network becomes a fairly complex resource management problem.

In addition, there is a challenge of providing the end-user with a consistent view of the content available via various devices within the home network. Even though broadcast service providers and internet based content providers traditionally enable their customers to easily discover the content that is available, each content service provider will only provide the information to support navigation and content selection for the content on its own network. As a result, the end-user has to deal with different user interfaces for navigating and selecting content available to the different home network devices.

Further, while the devices within the home network can share information about their content and device resources, these devices are typically not capable of sharing this information with devices and/or servers in other networks. Such sharing sometimes could also be desirable, e.g. to enable making all services that can be offered over the entire collection of content available to a particular user.

The current approach of various standardization alliances is to add more capabilities to the devices in a home network so that these devices can provide a more consistent view for content navigation and selection and can better manage networked resources. This approach, however, is a potential source of conflicts and may require the firmware upgrades in the devices within the home network.

### SUMMARY OF THE INVENTION

It is an object of the invention to provide a content management method and system that could improve on at least some of the challenges described above.

The embodiments of the present invention are adapted to operate in an environment including at least two devices in a home network, a proxy device communicatively connected to each of the at least two devices and to an external network, and a resource server communicatively connected to the proxy device via the external network.

In one aspect of the present invention, a method for the resource server to enable content navigation, discovery and management within the home network is provided. The method includes receiving, from the proxy device, content-related information obtained by the proxy device from each of the at least two devices, where the term “content-related information” is used to describe data regarding content available to each of the devices within the home network. The method further includes generating, based on at least part of the content-related information received from the proxy device, an integrated navigation interface, such as e.g. an electronic programming guide, enabling a user in the home network to navigate and/or manage content available to all of the at least two devices. Optionally, the method may further include the resource server providing at least a part of the integrated navigation interface to the home network for presentation to the user.

In an embodiment, the above-described method carried out by the resource server may also include receiving, from the proxy device, resource-related information obtained by the proxy device from each of the at least two devices, where the term “resource-related information” is used to describe data regarding configuration, capabilities, and/or functionality of the device. The method may further include scheduling recording of content, allocating storage capacity for the recording of content, and/or scheduling user access of content based on at least part of the resource-related information received from the proxy device. Such an embodiment is advantageous for providing centralized management of the different devices and content within the home network.

The gist of the invention resides in using a proxy device, such as e.g. a DLNA-compatible proxy server or a proxy server compatible with multiple standards, connected to the devices within and via the home network and also connected to the resource server via an external network. The proxy device can obtain content-relation information and, possibly, also resource-related information from all of the devices within the home network and provide that information to the resource server, via the external network. Employing such a proxy device solves the problem of the devices within the home network not being able to share information about their content and/or device resources with devices and/or servers in other networks and allows the resource server to create a single integrated navigation interface for navigating and managing content available to all of the devices within the home network. In this manner, the problem of the user having to deal with different user interfaces on different devices within the home network may be eliminated. In addition, the resource server having information regarding content and capabilities of the devices within the home network allows centralized management of the resources within the home network, which removes the need for firmware upgrades to the devices in the home network as the new features can be realized via additions to the resource server. The centralized management also reduces the potential for conflicts between the different devices within the home network, as compared with the prior art solutions.

In the present description, discussions of DLNA-compatible devices are equally valid for devices compatible with other standards or devices compatible with multiple standards at the same time.

In various embodiments, the content-related and/or resource-related information may also be obtained from outside of the home network. For example, operators often have systems that allow keeping track of what devices are included in a particular home network (e.g. a Cisco 4400 zapper and a Philips 7000 PVR) and what content is accessible for these devices. The resource server can obtain content-related information and/or resource-related information from such operators.

In an embodiment, the method carried out by the resource server may further include receiving information related to content requests from further devices outside of the home network. Such information may allow the resource server to have a global view of all subscribers and schedule recording of content, allocate storage capacity for the recording of content, and/or schedule user access of content taking into account the received information related to the content requests, thereby minimizing resource/content contention.

In an embodiment, the resource server may also generate device-specific integrated navigation interfaces for at least some of the devices in the home network, such interfaces being based on at least part of the content-related information and/or on at least part of the resource-related information obtained by the proxy device from all of the devices in the home network. In this manner, for each device within the home network, an individualized interface may be created. Such an individualized interface would advantageously allow navigation and management′ of the content available to all of the different devices within the home network while taking into consideration capabilities of the particular device for which the individualized interface was created.

In an embodiment, content navigation and/or management as described in the present application may advantageously be tailored to content which a user specifically expressed an interest in accessing and/or to content that has been predicted to be of interest to the user.

In an embodiment, the resource server may be configured for receiving information when devices are added to or removed from the home network. Receiving such information allows the resource server introducing appropriate corresponding changes to the integrated interface.

In another aspect of the present invention, a resource server configured for carrying out one or more of the steps of the method described above is proposed.

In yet another aspect of the invention, operating within the same environment as described above, a method for a proxy device to enable content navigation, discovery and management within the home network is provided. The method includes the proxy device obtaining content-related information from each of the at least two devices and providing the obtained content-related information to the resource server. A proxy device configured for carrying out such method is also provided.

In an embodiment, the proxy device may be included within one of the devices within the home network, such as e.g. a set-top box or a media controller.

In an embodiment, the proxy device may be configured for receiving, from the resource server, at least a part of an integrated navigation interface, such as e.g. an electronic programming guide, generated based on at least part of the content-related information provided to the resource server and enabling a user in the home network to navigate and/or manage content available to all of the at least two devices, and presenting at least a part of the integrated navigation interface to the user. In other embodiments, individual devices within the home network, rather than the proxy device, may receive integrated interfaces from the resource server for the presentation to the user.

In an embodiment, the proxy device may advantageously be configured to act as a local server that can store services and/or content that is not available within the home network, such as e.g. a catalogue of content that some or all of the devices within the home network are capable of presenting to the user.

According to a further aspect of the invention a system is proposed for content navigation, discovery and management. The system includes at least two devices in a home network, a proxy device adapted to be communicatively connected to each of the at least two devices and to an external network, and a resource server adapted to be communicatively connected to the proxy device via the external network. The proxy device is configured to obtain content-related information from each of the at least two devices and provide the obtained content-related information to the resource server. The resource server is configured to generate, based on at least part of the content-related information provided by the proxy device, an integrated navigation interface enabling a user in the home network to navigate and manage content available to all of the at least two devices and provide the integrated navigation interface to the home network for presentation to the user.

According to an aspect of the invention a computer program element is proposed. The computer program element is, when being executed by a processor, adapted to carry out a method for use in a resource server and/or a method for use in a proxy device having one or more of the above mentioned features. This advantageously enables the resource server and/or the proxy device to be implemented in software.

Hereinafter, embodiments of the invention will be described in further detail. It should be appreciated, however, that these embodiments may not be construed as limiting the scope of protection for the present invention.

### BRIEF DESCRIPTION OF THE DRAWINGS

Aspects of the invention will be explained in greater detail by reference to exemplary embodiments shown in the drawings, in which:

FIG. 1 shows an environment for enabling content navigation and content management within a home network, according to one embodiment of the present invention; and

FIG. 2 shows a block diagram of a proxy device, according to one embodiment of the present invention;

FIG. 3 shows a block diagram of a resource server, according to one embodiment of the present invention; and

FIG. 4 shows a flow diagram of method steps for enabling content navigation and content management within a home network, according to one embodiment of the present invention.

### DETAILED DESCRIPTION OF THE DRAWINGS

The invention involves the migration of at least some of the content discovery and resource management tasks from a home network to a remote server.

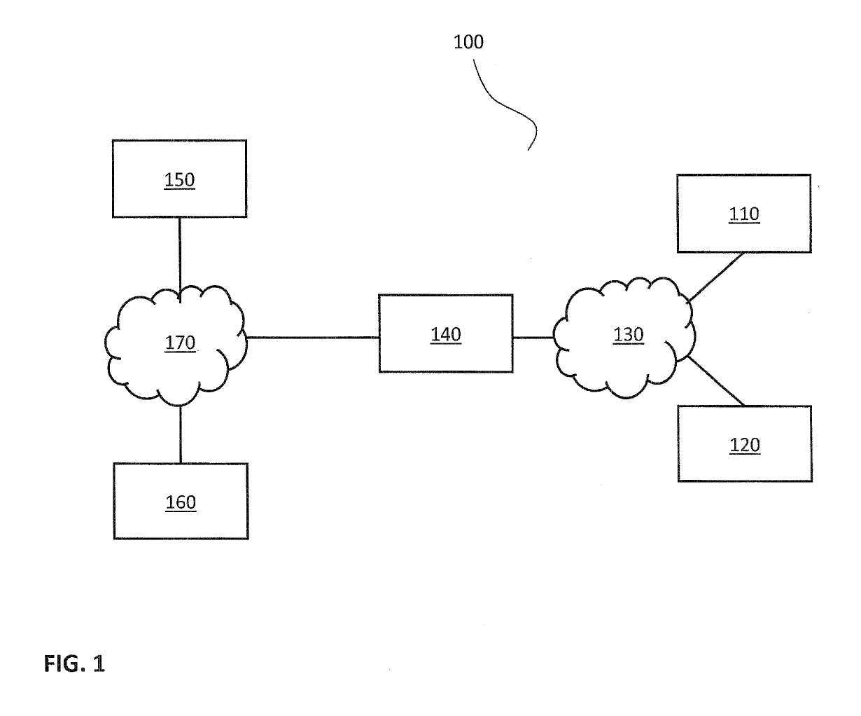

Hereto a system for content navigation and content management within the home network is proposed, such as e.g. shown in FIG. 1.

As shown in FIG. 1, a system 100 includes a first device 110 and a second device 120 within a home network 130. The system 100 further includes a proxy device 140 communicatively connected to the first and second devices 110 and 120 via the home network 130. Each of the first and second devices 110 and 120 could be a DLNA-compatible home network device and could comprise one or more of a media receiver device, a media storage/server device, a media renderer device, or a media controller device. The media receiver is a device that can receive media content from external sources such as e.g. content delivered via a broadcast network, content delivered via internet streaming, or content uploaded from (video) cameras. Such a device could be e.g. a set top box (STB). The media storage/server is a device that can store media content and serve as a source of media content for other devices. Such a device could be e.g. a video/audio/image recorder, a hard drive, a local music library server, a local photo archive, a mobile phone, or a personal computer. The media renderer is a device that can display or play to the user video/audio media content, such as e.g. a television or a music player. The media controller is a device that can control how and where to store and/or render media content. Of course, each of the first and second devices could combine functionalities of the media receiver, media storage/server, media renderer, and media controller. For example, a mobile phone within the home network 130 could serve as both a media storage device and a media renderer or the STB could serve as a media receiver, a media server, and a media controller.

The home network 130 further includes a proxy device 140, such as e.g. a DLNA-compatible proxy server. On one hand, the proxy device has a connection to the first and second devices 110 and 120 via the home network 130. On the other hand, the proxy device has a connection to a resource server 160 and, optionally, to a content server 150 via a connection to an external (broadband) network 170.

Via the connection to the home network 130, the proxy device 140 can obtain content-related and/or resource-related information from the first and second devices 110 and 120. The proxy device 140 can also load data and/or commands to the first and second devices 110 and 120.

Via the connection to the external network 170, the proxy device can load data to and obtain data from the resource server 160 and/or the content server 150. The proxy device 140 enables the resource server 160 to interrogate and manage the resources and content available within the home network 130. The content server 150 is a server for remotely storing content that could be provided to the devices within the home network 130. The resource server 160 could be included within the content server 150, or vice versa.

While FIG. 1 illustrates the proxy device 140 as a device separate from the first and second devices 110 and 120, in other embodiments, the proxy device 140 could be included within the first device 110 or the second device 120. For example, the proxy device 140 could be included within a STB in the home network 130.

Furthermore, even though the proxy device 140 is described in the present application as a single device, the description also covers embodiments where such a single device includes multiple proxy devices combined in one proxy. This could be useful e.g. in a home network that includes different device classes (e.g. DLNA-devices, UPnP-devices, HPNA-devices, etc.). In such an environment the proxy device 140 could include multiple proxies logical per device class and physically combined in one proxy device.

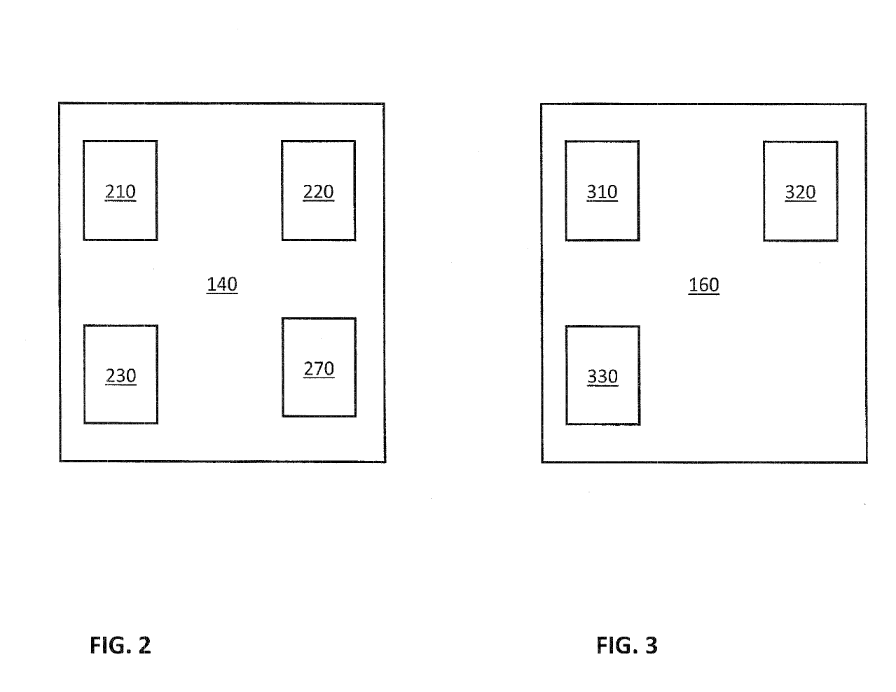

As shown in FIG. 2, in one embodiment, the proxy device 140 includes a processor 210, a home network interface 230 for connecting to the home network 130, and an external network interface 270 for connecting to the external network 170. The proxy device could also optionally include a data storage unit 220. Similarly, as shown in FIG. 3, in one embodiment, the resource server 160 includes a processor 310, an interface 320 for communicating data with the proxy device 140, and, optionally, a data storage unit 330.

The operation of the system 100 is now described in greater detail with references to FIGS. 2-4.

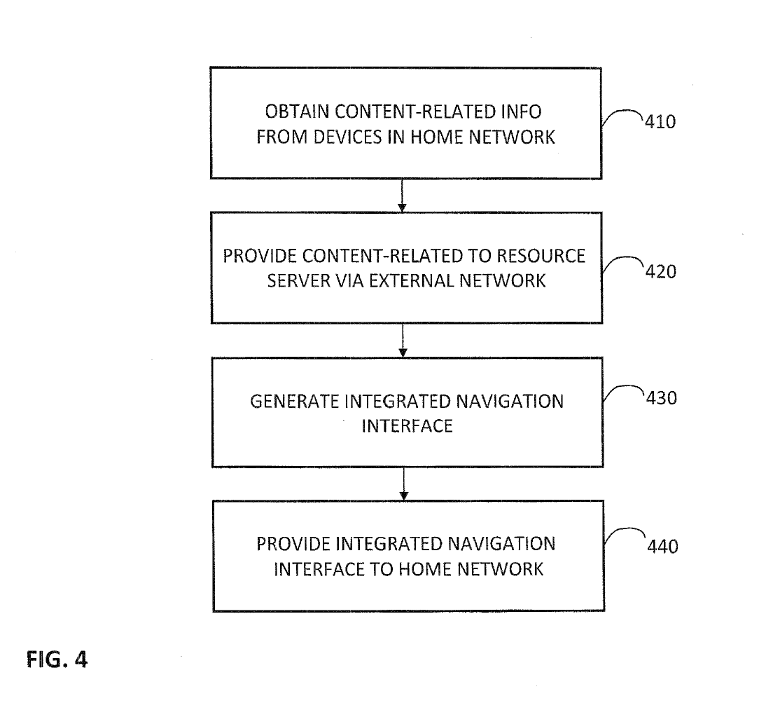

FIG. 4 shows a flow diagram of method steps for enabling content navigation and content management within the home network 130, according to one embodiment of the present invention. While the method steps are described in conjunction with FIGS. 1-3, persons skilled in the art will recognize that any system configured to perform the method steps, in any order, is within the scope of the present invention.

The method begins in step 410, where the proxy device 140 obtains, via the home network interface 230, content-related information from each of the devices 110 and 120. Optionally, the proxy device 140 also obtains resource-related information from each of the devices 110 and 120. To that end, the proxy device 140 could crawl the home network 130 (i.e., examine the home network 130 in a methodic and comprehensive manner) to identify devices within the network (i.e., devices 110 and 120), their content and/or capabilities. In DLNA, such functionality would rely on UPnP and device discovery would rely on Simple Service Discovery Protocol (SSDP).

In one embodiment, the proxy device 140 obtains information from the devices 110 and 120 upon receipt of an instruction from the resource server 160 to do so. In other embodiments, the proxy device 140 may be configured to obtain information from the devices 110 and 120 periodically or triggered by certain events within the home network 130 or the external network 170.

As used herein, the term “proxy device” describes a device that acts as an intermediary between one or more of the devices within the home network 130 on the one hand and one or more of the devices outside of the home network 130 on the other hand (such as e.g. the resource server 160). The term is used broadly to cover any communications between the devices within the home network and outside of the home network, independent of which device initiates communication and what kind of information and/or commands is exchanged. For example, the term covers both situations where the devices within the home network 130 use the proxy device to actively initiate communication with the devices outside of the home network 130 as well as situations where it is a device outside of the home network 130 that initiate communication with the devices within the home network 130 via the proxy device 140. In the latter situation the devices within the home network 130 may allow the proxy device 140 to e.g. use a discovery protocol to examine them to identify devices within the home network 130, detect content stored on the device, identify capabilities of the devices, load content on them (the content originating from e.g. the resource server 160), and/or configure the devices according to instructions received from the resource server 160.

In step 420, the proxy device 140 provides, via the external network interface 270, the obtained content-related information to the resource server 160. This illustrates one advantage of the proposed solution over the prior art. If in the prior art the device 110 and 120 could not share content-related and resource-related information with devices and/or servers outside of the home network 130 because they could only connect to devices in the same IP subnet, in the system 100 the resource server 160 can obtain content-related and/or resource-related information from the devices 110 and 120 via the proxy device 140.

In step 430, the processor 310 within the resource server 160 generates, based on the content-related information obtained by the proxy device 140 from the devices 110 and 120, an integrated navigation interface enabling a user in the home network 130 to navigate and manage content available to the devices 110 and 120. Such an integrated interface could comprise e.g. an EPG. The data storage unit 330 within the resource server 160 could be used to store the information obtained from the proxy device 140 and/or the generated integrated navigation interface.

Using the information obtained from the proxy device 140, the resource server 160 can create a complete picture of the content and resources available in the home network 130. The resource server 160 can also monitor new devices joining the home network 130 or devices being removed from the network 130 and update the integrated navigation interface accordingly. The resource server 160 can also monitor content that is present in, added to, or removed from the home network 130. For example if the first device 110 comprises a DVD player playing a particular DVD, this may be recognized by the resource server 160. The resource server 160 can also use the proxy device 140 to measure the quality of service between the devices 110 and 120 and for services that are delivered using the broadband network into the home network 130. A person skilled in the art would recognize that the implementation of such functionality would depend on the device type and class. For example, for DLNA and UPnP, the quality of service could be handled by the protocols called UPnP-QOS. For other protocols, active or passive network probing may reveal the network status. For example, active probing would send packets to destinations and measure round trip delays and would aggregate this information to access the quality of service.

Using the information obtained from the proxy device 140, the resource server 160 can also enable other services across all of the content available to the user of the home network, such as e.g. recommendations.

In step 440, the resource server 160 provides, via the interface 320, the integrated navigation interface to the home network 130 where it may be presented to the user. The integrated navigation interface could be e.g. a web-based user interface that can be displayed on any browser-capable device. In various embodiments, the integrated navigation interface or a part thereof may be provided to the proxy device 140, directly to the device 110 and/or device 120, or to any other device within or outside of the home network.

As the resource server 160 can combine obtained content-related information with additional metadata and advanced graphics, it can support a richer user experience that cannot be achieved with prior art solutions that use only local metadata. The integrated navigation interface may present to the user a content guide of content that is available on the local media server(s), on remote content servers, and of content that will be broadcast or become available over broadband in the future. The user can then use the integrated navigation interface to e.g. direct a media rendering device to a specific service or a specific piece of content or to indicate a desire to record a piece of content, e.g. via DLNA.

In one embodiment, the resource server 160 can generate an integrated navigation interface that includes a list of programming that is likely to be of interest to the user, provided that the proxy device 140 provides to the resource server 160 information indicative of user's interests. Furthermore, the resource server 160 can use specific instructions from the user and/or its knowledge of the user's preferences to construct a resource usage plan that maximizes the likelihood that the user will have the appropriate content available instantaneously at the desired quality level.

In one embodiment, the proxy device 140 may be a DLNA proxy implemented within the first device 110, where the first device comprises a DLNA-compatible STB. In such an embodiment, using the proxy device 140, the STB can access the resource server 160 and may receive instructions to use one or more discovery protocols for querying the home network 130 to detect other DLNA devices as described above. In the simplest form, based on the content-related information received from the proxy device 140, the resource server 160 only provides navigation data for the broadcast network to which the STB is connected. As the resource server 160 has a point to point connection with the devices 110 and 120 in the home network 130, the resource server 160 can be used to deliver a richer set of information regarding the services in the broadcast network.

In another embodiment, the resource server 160 may send the integrated navigation interface or a part thereof to a media controller which could be implemented as e.g. an application on a tablet computer, possibly within the first device 110. In such an embodiment, when the user selects the content, the media controller instructs the STB to tune to the relevant content and send it to the selected media renderer such as e.g. a TV set or an audio amplifier/speaker. The resource server 160 may use the proxy device 140, which could be implemented in an STB, to obtain information about the broadcast network and the available media rendering devices in the home network 130. The resource server 160 may then extend the information received from the proxy device 140 with data from service providers and third party content metadata providers. Such implementation allows simplifying the STB software and reducing the amount of EPG data that needs to be included in the broadcast channel. Reducing the amount of EPG data included in the broadcasting is advantageous because the constantly repeated broadcasting of EPG data requires significant bandwidth and data rates.

In yet another embodiment, the resource server 160 may also be used to deliver conditional access (CA) data and/or digital rights management (DRM) data, obtained from the service provider, to the devices 110 and 120 in the home network 130. Conventional delivery of keys (e.g. using EMMs) requires repeated transmissions of data as the delivery of the data by the target device is not certain. In turn, the repetitions require significant data rates as the data rate determines the amount of time that a receiver in a home network needs to wait in order to acquire all of the (updated) keys required to start descrambling a broadcast stream. Having a connection between the resource server 160 and the devices 110 and 120 in the home network 130 via the proxy device 140 advantageously allows reducing the amount of CA and/or DRM data that needs to be included in the broadcast network.

In further embodiments, the resource server 160 can also provide central management of the devices in the home network 130 by e.g. scheduling recordings of content on the devices, allocating storage capacity for the recordings, routing content streams to the appropriate rendering devices, and scheduling user access of content. Such centralized management can be performed based on at least part of the resource-related information and/or content-related information received from the proxy device 140.

Examples of how the centralized device management may occur are provided below.

For example, consider that the first device 110 comprises a STB with four tuners and the second device 120 comprises a STB with two tuners, with storage on each of the first and second devices 110 and 120 and an additional storage device within the home network 130. The additional storage device may be realized e.g. on a network drive. In such a system, based on the content-related data and/or device-related data obtained for these three devices in the home network 130 by the proxy device 140, the resource server 160 can plan recordings and allocate storage capacity so that there is maximum likelihood that the user's specific choices and predicted choices can be recorded without resource contention. Because resource management is no longer at the device level but at the network level across all devices, the resource management can be optimized.

In an embodiment, the resource server 160 may receive information related to content requests from further devices outside of the home network 130. In that manner, the resource server 160 may obtain a global view of all users in terms of their requests for content and schedule recording of content, allocate storage capacity for the recording and/or scheduler user access to content taking into consideration the global view. For example, if there is significant demand for specific programming, the resource server 160 may schedule providing particular content in off peak times to resolve this large scale contention. Or, if the user selects content for recording that is either available on demand or transmitted multiple times, the resource server 160 may either create a link to the on demand library or select a different time of transmission for recording to minimize resource contention.

In another embodiment, the resource server 160 may aggregate information related to viewing behavior across all of the devices within the home network 130 and, based on the aggregated information, construct a prediction of likely preferences for all devices within the home network 130. Alternatively or additionally, the resource server 160 may use the aggregated information to construct a prediction of likely preferences for individual devices in the home network 130. In this manner, viewing preferences may be tailored to a specific device in the home network 130 that has a specific viewing behavior associated with it.

Based on the information received from the proxy device 140, the resource server 160 may also generate device-specific navigation interfaces. Such interfaces could include push lists for portable devices that may be connected to the home network. For example, when a device connects to the home network 130, the resource server 160 may generate a library list based on the capacity capability of the device (e.g. device capacity, screen size, formats supported, etc.) and the total content available within the home network 130. This information could be included in the device profile or attached to some service exposed by the device.

The resource server 160 may further facilitate that the device is synched with this content automatically. The library lists may take into account capabilities of the device and/or specific viewing behavior of the user on the device.

In an embodiment, the proxy device 140 can send information to the resource server 160 regarding the device within the home network 130 that is presenting the integrated navigation interface to the user. The resource server 160 may then adapt the content information within the integrated navigation interface according to the history of the device as well as the type of device, provided that the proxy device 140 makes the history of the device as well as the type of device available to the resource server 160.

The resource server 160 may adapt its resource schedule to take into account the activities of the user with respect to the devices within the home network 130. provided that the proxy device 140 makes necessary information available to the resource server 160. For example, if the user is watching a particular program, the resource server 160 may stop certain recordings or reallocate recordings according to the devices available in the home network 130.

In an embodiment, the resource server 160 may also determine which advertisements should be played between content, should the advertising model be relevant. This can be done for both stored and live content and could be based on known or predicted user preferences or specific user instructions.

The resource server 160 may also adapt the service level based on the devices that are present in the home network 130. For example, if a network disk is added to the home network 130, the amount of content that is scheduled for recording may be increased.

The resource server 160 may also be configured, on the basis of the analysis of the infrastructure within the home network 130, to push parts of content such that the user can start viewing the content and by the time the pushed part of the content has been viewed the rest of the content can be pulled from the content server 150.

One way for implementing such functionality is illustrated in the following example. The first five minutes of content would be stored on a device within the home network 130. That way, whenever a user wishes to access the content, e.g. start watching a movie, he can do so immediately. While the user starts watching the movie, the rest of the movie, which was not stored within the home network 130, could be obtained from outside of the home network.

One embodiment could include a broadcast stream that repeats chunks of a movie with a certain repetition rate. The earlier segments are stored in the home network 130, which allows a lower repetition rate for later chunks in the content. As the user starts watching the movie, the appropriate device in the home network 130 will fetch the remaining parts necessary to decode the entire content. Such application leverages the fact that the first part of a movie is needed immediately, whereas later parts can be acquired while the user is viewing the first part. Depending on the playout time, different fetching priorities can be applied to the later parts of the movie. This can be reflected in selecting the infrastructure path used to fetch the part of the content.

The resource server 160 may use the proxy device 140 to obtain information regarding the ability of the devices within the home network 130 to handle CA/DRM rules and then use that information to determine which device within the home network 130 should make the recording. For example, a device that cannot respect the DRM rules would not be used to make the recording. Instead, the recording would be made on the device with the appropriate DRM capabilities.

Once the resource server 160 has created a resource utilization plan, the resource server 160 may communicate with the devices 110 and 120 within the home network 130 using the proxy device 140 or a proprietary proxy to program the various devices to make the appropriate recordings or deletions from storage.

The system 100 has the advantage that the STB or other consumer device within the home network 130 can be made as simple as possible. All that is required is a low level control API that can be driven by the resource server 160. The media navigation and control can be implemented on a separate device. It also may be implemented on the STB in the form of a web browser. The service definition, navigation display and logic can easily be updated by changing the resource server application that drives the devices in the home network 130. It is also possible to phase introduction of resource server functionality and make rapid changes to the function set by making changes to the resource server application. This removes the need to port this logic to each set top box or consumer device. Thus, the use of the proxy device 140 and the resource server 160 removes the need for firmware updates to the devices in the home network 130 as new features can be realized via additions to the resource server 160.

The resource server 160 may either schedule devices in the home network 130 to make recordings or may push triggers to each device to start recording in synchronization with the transmission. This enables the resource server 160 to resynchronize the recording schedule in response to last minute schedule changes.

In an embodiment, the resource server 160 may also use the proxy device 140 as a local storage unit or a server for services or content that is not available within the home network 130. Such services or content could be stored within the storage 220 in the proxy device 140. For example, if there is a catalogue of content that a device within the home network 130 is capable of viewing via broadband, the proxy device 140 may publish this content as being available within the home network 130 and either pass a URL to the device within the home network 130 making the DLNA query to find the content on the broadband network or the content is streamed to the local device over broadband and then onto the device making the query using the home network 130.

One advantage of the present invention is that the user may be provided with a consistent, integrated, view of the content available via various devices within the home network irrespective of the protocol used (DLNA, UPnP, HPNA, etc.). Another advantage is that the devices within the home network are able to share information about their content and device resources with devices and/or servers outside of the home network. Yet another advantage is that only minimal firmware upgrades are necessary for devices within the home network, as the new functionality can be implemented via changes to the resource server.

It is to be understood that any feature described in relation to any one embodiment may be used alone, or in combination with other features described, and may also be used in combination with one or more features of any other of the embodiments, or any combination of any other of the embodiments. One embodiment of the invention may be implemented as a program product for use with a computer system. The program(s) of the program product define functions of the embodiments (including the methods described herein) and can be contained on a variety of non-transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory or flash memory) on which alterable information is stored. Moreover, the invention is not limited to the embodiments described above, which may be varied within the scope of the accompanying claims.

1. In an environment comprising at least two devices in a home network, a proxy device, such as e.g. a Digital Living Network Alliance compatible proxy device adapted to be communicatively connected to each of the at least two devices and to an external network, and a resource server adapted to be communicatively connected to the proxy device via the external network, a method for the resource server, the method comprising:
receiving content-related information obtained by the proxy device from each of the at least two devices,
generating, based on at least part of the content-related information, an integrated navigation interface enabling a user in the home network to navigate and/or manage content available to all of the at least two devices, and
optionally, providing at least a part of the integrated navigation interface to the home network for presentation to the user.

2. The method according to claim 1, further comprising:
receiving resource-related information obtained by the proxy device from each of the at least two devices, and
based on at least part of the resource-related information, scheduling recording of content, allocating storage capacity for the recording of content, and/or scheduling user access of content.

3. The method according to claim 2, further comprising receiving information related to content requests from further devices outside the home network, wherein the steps of scheduling recording of content, allocating storage capacity for the recording of content, and/or scheduling user access of content are performed taking into account the information related to the content requests.

4. The method according to claim 2, further comprising generating a device-specific integrated navigation interface for one of the at least two devices based on at least part of the content-related information obtained by the proxy device from all of the at least two devices and at least part of the resource-related information obtained by the proxy device from the one of the at least two devices.

5. The method according to claim 1, wherein the content comprises content indicated by the user and/or content predicted to be of interest to the user.

6. The method according to claim 1, further comprising receiving, from the proxy device, an indication that an additional device has joined the home network and/or an indication that one of the at least two devices has been removed from the home network.

7. The method according to claim 6,
wherein upon receiving the indication that the additional device has joined the home network, the method further comprises:
receiving content-related information obtained by the proxy device from the additional device,
generating a modified integrated navigation interface by modifying the integrated navigation interface based on at least part of the content-related information obtained by the proxy from the additional device, the modified integrated navigation interface enabling the user in the home network to navigate and manage content available to all of the at least two devices and the additional device, and
optionally, providing the modified integrated navigation interface to the home network for presentation to the user;
and/or
wherein upon receiving the indication that one of the at least two device has been removed from the home network, the method further comprises:
generating a modified integrated navigation interface by modifying the integrated navigation interface to indicate that one of the at least two devices that has been removed from the home network, and
optionally, providing the modified integrated navigation interface to the home network for presentation to the user.

8. The method according to claim 1, wherein the proxy device is included within one of the at least two devices, preferably within a set-top box or a media controller within the home network.

9. A resource server configured for performing method steps according to claim 1.

10. In an environment comprising at least two devices in a home network, a proxy device adapted to be communicatively connected to each of the at least two devices and to an external network, and a resource server adapted to be communicatively connected to the proxy device via the external network, a method for the proxy device, the method comprising:
obtaining content-related information from each of the at least two devices, and
providing the obtained content-related information to the resource server.

11. The method according to claim 10, further comprising:
receiving, from the resource server, an integrated navigation interface generated based on at least part of the content-related information provided to the resource server and enabling a user in the home network to navigate and/or manage content available to all of the at least two devices, and
presenting at least a part of the integrated navigation interface to the user.

12. The method according to claim 10, further comprising storing services and/or content that is not available within the home network, such as e.g. a catalogue of content that at least one of the at least two devices is capable of presenting to the user.

13. A proxy device, preferably included within one of the at least two devices and, most preferably, within a set-top box or a media controller within the home network, configured for performing method steps according to claim 10.

14. A computer program comprising software code portions configured for, when executed by a processor, performing the steps of the method as defined in claim 1.

15. A system comprising:
at least two devices in a home network;
a proxy device adapted to be communicatively connected to each of the at least two devices and to an external network; and
a resource server adapted to be communicatively connected to the proxy device via the external network;
wherein the proxy device is configured to:
obtain content-related information from each of the at least two devices, and
provide the obtained content-related information to the resource server; and
wherein the resource server is configured to:
generate, based on at least part of the content-related information provided by the proxy device, an integrated navigation interface enabling a user in the home network to navigate and/or manage content available to all of the at least two devices, and
optionally, provide at least a part of the integrated navigation interface to the home network for presentation to the user.

16. The method according to claim 1, wherein the proxy device comprises a Digital Living Network Alliance-compatible proxy device.

17. The method according to claim 1, wherein the integrated navigation interface comprises an electronic programming guide.

18. The method according to claim 10, wherein the integrated navigation interface comprises an electronic programming guide.

19. A computer program comprising software code portions configured for, when executed by a processor, performing the steps of the method as defined in claim 10.
